(19) United States
(12) Patent Application Publication
(10) Pub. No.: US 2024/0226772 A1
(43) Pub. Date: Jul. 11, 2024

(54) OIL-WATER SEPARATION DEVICE

(71) Applicant: FUJI CORPORATION, Chiryu (JP)

(72) Inventors: Osamu NAGAI, Nagoya-shi (JP); Jun YANAGISAKI, Toyota-shi (JP)

(73) Assignee: FUJI CORPORATION, Chiryu (JP)

(21) Appl. No.: 18/559,344

(22) PCT Filed: Jun. 2, 2021
(86) PCT No.: PCT/JP2021/021028

§ 371 Date: Nov. 7, 2023

(51) Int. Cl. B01D 17/02

(52) U.S. Cl. CPC B01D 17/0211; B01D 2221/14; B01D 2257/80

(57) ABSTRACT

An oil-water separation device that efficiently separates and discharges oil from a mixed liquid includes a first chamber and a second chamber separated in a separation container, a first discharge port and a second discharge port formed in the first chamber and the second chamber, respectively, on a side surface of the separation container, a partition plate configured to separate the first chamber and the second chamber, the partition plate including a lower partition plate erected on a bottom surface of the separation container and an upper partition plate including a guide section that inclines from the first chamber toward the second chamber above the lower partition plate, and a communication section between the lower partition plate and the upper partition plate configured to connect the first chamber and the second chamber to each other.

### TECHNICAL FIELD

The present disclosure relates to an oil-water separation device configured to efficiently separate and discharge a mixed liquid of a coolant and a lubricating oil.

### BACKGROUND ART

In a machine tool, the lubricating oil is supplied to the sliding portion so that the slide member is stably slid. Since the lubricating oil flows out from the sliding surface of the slide member, the lubricating oil is received and collected by the oil pan, but a coolant used for cooling during workpiece machining is mixed therein. Such lubricating oil is separated from the coolant, and then collected and discarded. Patent Literature 1 below discloses an oil-water separation device that separates a coolant and a lubricating oil. The oil-water separation device is a separation container with a large dimension in a depth direction, a lubricating oil discharge port and a coolant discharge port are formed in side wall surfaces on both sides in a longitudinal direction, and multiple flow plates are provided therebetween. Only one side of the multiple flow plates is alternately joined to the side wall surfaces facing each other with a narrow width, and a water channel meandering in the longitudinal direction is formed. Furthermore, on the coolant discharge port side, an oil-water separation plate that forms a communication section at the bottom part by positioning away from the bottom surface is provided.

### PATENT LITERATURE

Patent Literature 1: JP-UM-A-H6-007802

### BRIEF SUMMARY

### Technical Problem

In the oil-water separation device of the conventional art, when the lubricating oil and the coolant are mixed together, the mixed liquid is composed such that the coolant with a high specific gravity settles at the bottom while the lubricating oil with a low specific gravity floats up on the liquid surface. Accordingly, in the oil-water separation device in which the communication section is formed at the bottom part, only the coolant passes through the communication section, and the coolant separated from the lubricating oil is discharged from the coolant discharge port side. However, in such an oil-water separation device, since the mixed liquid is separated over time at the meandering portion with a large volume, the lubricating oil that accumulates on the water surface spreads to a range away from the lubricating oil discharge port. Then, the lubricating oil may stagnate in the oil-water separation device for a long time without flowing out, causing the lubricating oil thus stagnated to deteriorate and generate an abnormal odor.

An object of the present disclosure, in order to solve such issues, is to provide an oil-water separation device that efficiently separates and discharges oil from a mixed liquid.

### Solution to Problem

An oil-water separation device according to an aspect of the present disclosure includes a first chamber and a second chamber separated in a separation container, a first discharge port and a second discharge port formed in the first chamber and the second chamber, respectively, on a side surface of the separation container, a partition plate configured to separate the first chamber and the second chamber, the partition plate including a lower partition plate erected on a bottom surface of the separation container and an upper partition plate including a guide section that inclines from the first chamber toward the second chamber above the lower partition plate, and a communication section between the lower partition plate and the upper partition plate configured to connect the first chamber and the second chamber to each other.

### Advantageous Effects

With the above configuration, for example, when the coolant and the lubricating oil are introduced together into the first chamber of the separation container, even when the mixed liquid reaches the bottom part due to the force of falling, the entry of the mixed liquid into the second chamber is prevented by the lower partition plate. Even in this case, the lubricating oil that attempted to pass over the lower partition plate and enter the second chamber is guided to the first chamber by the guide section of the upper partition plate at a position where the lubricating oil floats up due to the low specific gravity, and collected on the liquid surface of the same chamber. On the other hand, the coolant with a high specific gravity moves from the first chamber to the second chamber through the communication section. In the first chamber, the lubricating oil is discharged from the first discharge port, and in the second chamber, the coolant is discharged from the second discharge port.

### BRIEF DESCRIPTION OF DRAWINGS

FIG. 1 is a perspective view illustrating a machine tool including an oil-water separation device.

FIG. 2 is a perspective view illustrating an embodiment of the oil-water separation device.

FIG. 3 is a cross-sectional view illustrating an embodiment of the oil-water separation device.

FIG. 4 is a cross-sectional view illustrating an embodiment of the oil-water separation device.

FIG. 5 is a cross section illustrating a reference example of the oil-water separation device.

### DESCRIPTION OF EMBODIMENTS

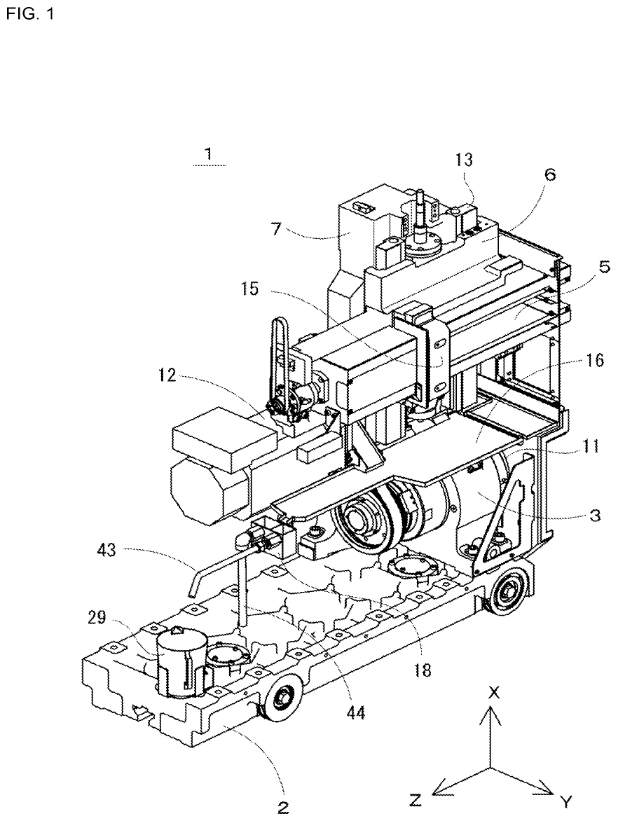

An embodiment of an oil-water separation device according to the present disclosure will be described below with reference to the drawings. FIG. 1 is a perspective view illustrating an internal structure of a machine tool including an oil-water separation device according to the present embodiment, as viewed from a rear side. Machine tool 1 is configured with movable bed 2 which is movable on a base. Spindle device 3 is mounted on movable bed 2, and spindle chuck 11 for gripping workpiece W is provided on the front side of the machine body on the right side of the drawing. Spindle device 3 includes spindle motor 12, and spindle chuck 11 is rotated by rotation output of spindle motor 12. In the present embodiment, the description will be made by defining a front-rear direction of machine tool 1 as a Z axis, defining an up-down direction as an X axis, and defining a width direction as a Y axis.

On the front side of the machine body, a turret device including multiple tools is positioned above spindle chuck 11. The turret device (not shown) is assembled to a drive device that moves the tools relative to a workpiece. Machine tool 1 is a two-axis lathe in which a machining axis of the tools, that is, a movement direction of the turret device is set to two directions which are the Z axis direction and the X axis direction. The turret device is fixed to a front end portion of Z axis slide 5 which is slidable in the Z axis direction, and a Z axis drive device including Z axis slide 5, and an X axis drive device on which the Z axis drive device is mounted are assembled to column 7 erected on movable bed 2.

Vertical guide rail 13 is formed on column 7, and X axis slide 6 is slidably assembled to guide rail 13. X axis slide 6 is configured to lift and lower by the output of the servo motor transmitted through the ball screw mechanism. Guide holder 15 is fixed to X axis slide 6, and Z axis slide 5, which passes through guide holder 15, is assembled in a slidable manner. Z axis slide 5 is configured to move back and forth by the output of the servo motor transmitted through the ball screw mechanism.

Machine tool 1 uses lubricating oil to be able to perform accurate position control on Z axis slide 5 and X axis slide 6. The lubricating oil is supplied to multiple drive portions such as sliding surfaces of Z axis slide 5 and X axis slide 6 and bearings of the ball screw mechanism. However, such lubricating oil flows out from the sliding surface or the like, but in this state, it could not only contaminate spindle device 3 or the like, but also fall into the coolant tank provided below movable bed 2. Machine tool 1 is provided with oil pan 16 on spindle device 3 in order to collect lubricating oil flowing down from the drive portions such as Z axis slide 5.

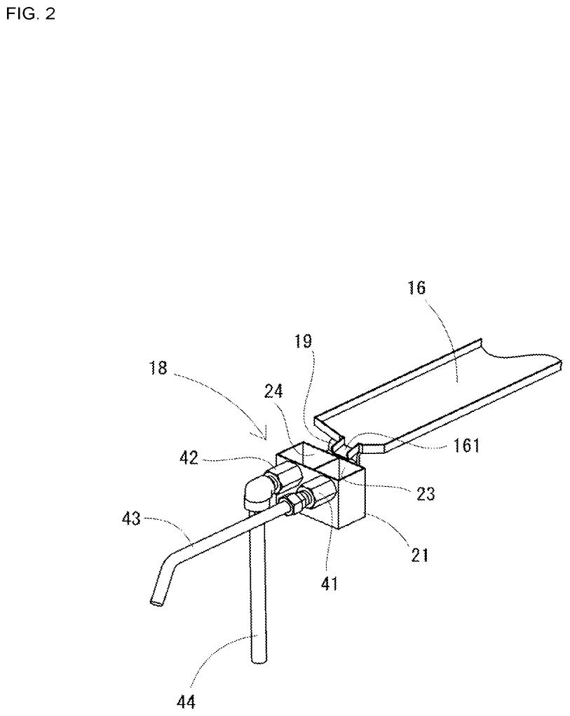

Oil pan 16 is formed such that the rear side of the machine body on the front side of the drawing is narrow, and is inclined such that the lubricating oil and the coolant gather in discharge section 161 at the rear end. Here, oil pan 16 does not receive only the lubricating oil, but the coolant used as the cooling water during workpiece machining is scattered from the machining chamber and mixed into oil pan 16. Therefore, when discarding the lubricating oil, the lubricating oil needs to be separated from the coolant, and thus oil-water separation device 18 is installed below discharge section 161. FIG. 2 is an enlarged perspective view illustrating oil-water separation device 18.

Oil-water separation device 18 is formed by separation container 21 having a cubic shape opened upward, and the inside of oil-water separation device 18 is divided into two chambers, oil collection chamber 23 and coolant collection chamber 24. Oil-water separation device 18 is installed such that oil collection chamber 23 is positioned directly below discharge section 161, and the lubricating oil and the coolant directly flow into oil collection chamber 23. Oil collection chamber 23 is a chamber in which the lubricating oil is collected, and adjacent coolant collection chamber 24 is a chamber in which the coolant, from which the lubricating oil is removed, is accumulated.

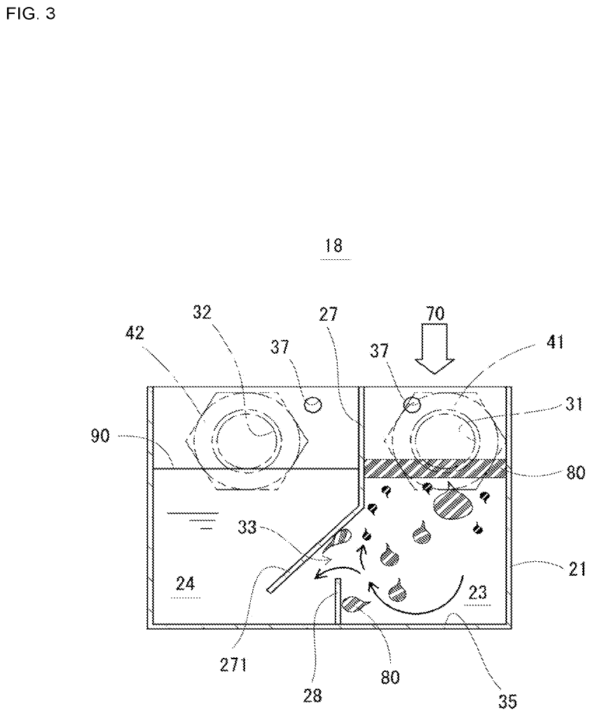

On the side surface of separation container 21, first discharge port 31 and second discharge port 32 (refer to FIG. 3) are formed at the same height, and sockets 41 and 42 with the same female screw are joined thereto. Further, oil pipe 43 extending in the horizontal direction is connected to socket 41, and coolant pipe 44 is connected to socket 42 while changing the direction of coolant pipe 44 downward by an elbow. As illustrated in FIG. 1, ahead of oil pipe 43, oil collection can 29 for collecting waste liquid is installed on movable bed 2, and the coolant discharged from downward-facing coolant pipe 44 flows down to the coolant tank below movable bed 2.

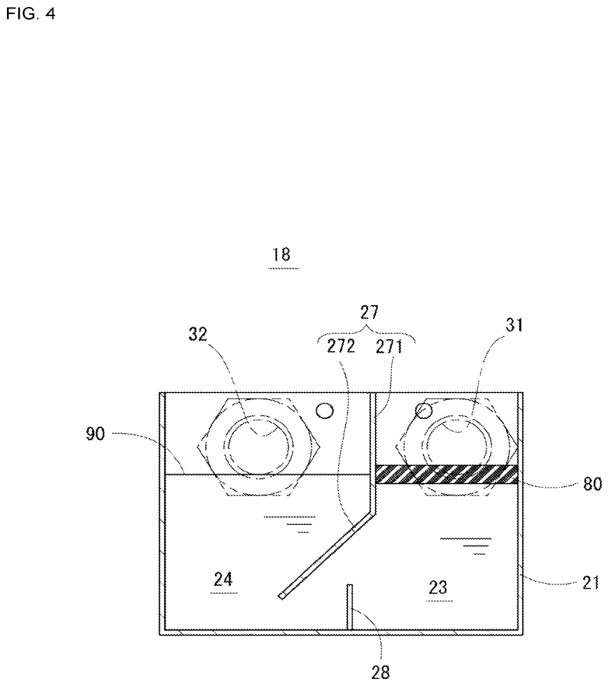

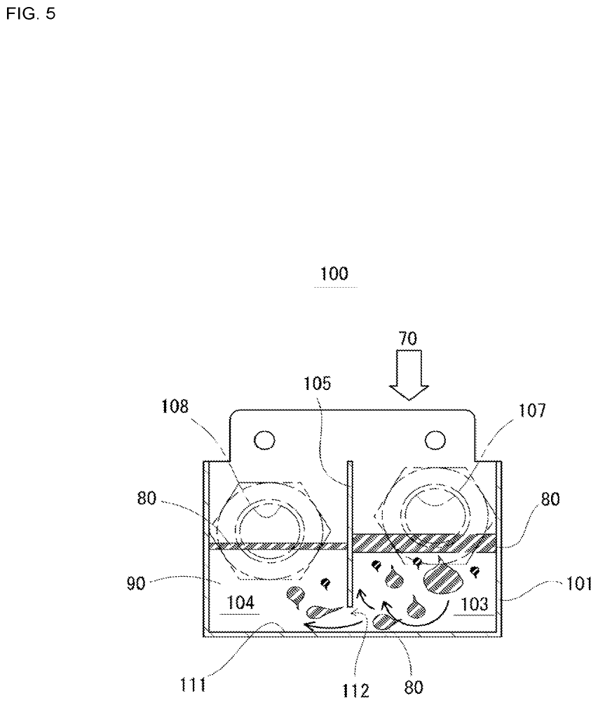

FIGS. 3 and 4 are cross-sectional views illustrating oil-water separation device 18, and illustrate the separation status. In addition, FIG. 5 is a cross section illustrating a reference example of the oil-water separation device. First, in oil-water separation device 100 illustrated in FIG. 5, as in the present embodiment, separation container 101 opened upward is divided into two chambers of oil collection chamber 103 and coolant collection chamber 104, and first and second discharge ports 107 and 108 are formed. Partition plate 105 that divides the two chambers forms communication section 112 by positioning away from bottom surface 111 as in the conventional art. Here, when mixed liquid 70 into which the lubricating oil and the coolant are introduced together as indicated by the outlined arrow falls into oil collection chamber 103, lubricating oil 80 with a low specific gravity floats up while coolant 90 with a high specific gravity enters coolant collection chamber 104 through communication section 112.

However, lubricating oil 80 also sinks down to the bottom due to the force of falling of mixed liquid 70 introduced into oil collection chamber 103, and some of lubricating oil 80 directly passes through communication section 112 and enters coolant collection chamber 104. Such issues can be solved by allowing the separation of mixed liquid 70 gradually by increasing the depth of the separation container or increasing the distance to the discharge port, similar to the conventional art. However, in a case where the object is to separate and discharge lubricating oil 80 in a short time, the size of separation container 101 has to be reduced. Then, introduced mixed liquid 70 reaches communication section 112 and enters coolant collection chamber 104 at a constant rate.

Oil-water separation device 18 of the present embodiment has a configuration in which lubricating oil 80 and coolant 90 are efficiently separated even in small separation container 21. In oil-water separation device 18, separation container 21 is divided into oil collection chamber 23 and coolant collection chamber 24 as described above, and the partition plate includes upper partition plate 27 and lower partition plate 28. Communication section 33 is formed between upper partition plate 27 and lower partition plate 28, and it is configured such that coolant 90, from which lubricating oil 80 is removed, from mixed liquid 70 flowing down to oil collection chamber 23 indicated by the outlined arrow is sent from communication section 33 to coolant collection chamber 24.

First, lower partition plate 28 is erected on bottom surface 35, and plays a role of preventing mixed liquid 70, which is introduced into oil collection chamber 23 and reaches bottom surface 35, from flowing to coolant collection chamber 24. Therefore, most of lubricating oil 80 with a low specific gravity rises in oil collection chamber 23. However, even in this case, a certain amount of lubricating oil 80 still flows into coolant collection chamber 24 as indicated by the arrow in FIG. 3. In order to prevent the entry of lubricating oil 80 that flows into coolant collection chamber 24, upper partition plate 27 is formed with guide section 272 that extends into coolant collection chamber 24 side.

Guide section 272 of upper partition plate 27 guides lubricating oil 80 that attempts to pass over lower partition plate 28 and enter coolant collection chamber 24 to oil collection chamber 23 at a position where lubricating oil 80 floats up. Upper partition plate 27 includes partition section 271, which extends in the up-down direction similar to lower partition plate 28, in an upper portion sandwiched between first discharge port 31 and second discharge port 32, and guide section 272 that inclines toward coolant collection chamber 24 side is continuously formed on a lower side of partition section 271. Guide section 272 extends to a position where the tip end thereof is lower than the upper end of lower partition plate 28.

Two attachment holes 37 are formed in a side surface of separation container 21 opposite to the side surface in which first and second discharge ports 31 and 32 are formed, and separation container 21 is configured to be screwed to bracket 19 joined to the bottom surface of oil pan 16. Oil-water separation device 18 is attached as illustrated in FIG. 1 such that first discharge port 31 and second discharge port 32 have the same height. Sockets 41 and 42 are cylindrical members having a hexagonal outer shape. Therefore, attaching first discharge port 31 and second discharge port 32 at the same height is achieved by placing a level on top of sockets 41 and 42 for horizontal leveling.

Next, operating effects of oil-water separation device 18 will be described. In machine tool 1, the lubricating oil is supplied to drive portions during operation, and the lubricating oil dripping down is received by oil pan 16. Further, the coolant scattered in the machining chamber is also mixed into oil pan 16. Such lubricating oil and coolant flow on oil pan 16, fall from discharge section 161 as mixed liquid 70, and enter oil-water separation device 18. In oil-water separation device 18, lubricating oil 80 with a low specific gravity floats up to the top from mixed liquid 70 that fell into oil collection chamber 23, but some of lubricating oil 80 flows around to coolant collection chamber 24 side.

However, lubricating oil 80 that has passed over lower partition plate 28, due to the presence of guide section 272 of upper partition plate 27 at a position where lubricating oil 80 floats up, rises along the inclination of guide section 272 and gathers on liquid surface of oil collection chamber 23. On the other hand, the coolant with a high specific gravity sinks under lubricating oil 80 in oil collection chamber 23 and is sent from communication section 33 to coolant collection chamber 24. Lubricating oil 80 exists on the liquid surface of oil collection chamber 23, and the coolant exists on the liquid surface of coolant collection chamber 24. Such lubricating oil 80 flows from first discharge port 31 to oil pipe 43 and is collected in oil collection can 29 as a waste liquid. Further, coolant 90 passes through coolant pipe 44 from second discharge port 32, and accumulates in the coolant tank where coolant 90 has flowed down to be reused.

Thus, according to oil-water separation device 18 of the present embodiment, since separation container 21 is configured to be divided into two chambers by upper partition plate 27 and lower partition plate 28, even small separation container 21 can prevent lubricating oil 80 from entering coolant collection chamber 24 and efficiently separate lubricating oil 80 from coolant 90. Since the volume of separation container 21 is small, lubricating oil 80 and coolant 90 can be separated and collected in a short time, and in particular, no abnormal odor is generated by leaving lubricating oil 80 for a long time. In addition, small oil-water separation device 18 can be attached in a space-saving manner, and does not interfere with small machine tool 1.

Although one embodiment of the present disclosure has been described, the present disclosure is not limited to the embodiment, and various modifications can be made without departing from the gist thereof.

For example, in the embodiment described above, upper partition plate 27 is formed by being divided into two flat surfaces of partition section 271 and guide section 272, but the upper partition plate may be formed with a single curved surface.

### REFERENCE SIGNS LIST

1: Machine tool, 3: Spindle device, 5: Z axis slide, 6: X axis slide, 16: Oil pan, 18: Oil-water separation device, 21: Separation container, 23: Oil collection chamber, 24: Coolant collection chamber, 27: Upper partition plate, 28: Lower partition plate, 70: Mixed liquid, 80: Lubricating oil, 90: Coolant, 272: Guide section

1. An oil-water separation device comprising:
a first chamber and a second chamber separated in a separation container;
a first discharge port and a second discharge port formed in the first chamber and the second chamber, respectively, on a side surface of the separation container;
a partition plate configured to separate the first chamber and the second chamber, the partition plate including a lower partition plate erected on a bottom surface of the separation container and an upper partition plate including a guide section that inclines from the first chamber toward the second chamber above the lower partition plate; and
a communication section between the lower partition plate and the upper partition plate configured to connect the first chamber and the second chamber to each other.

2. The oil-water separation device according to claim 1, wherein, in a case where an oil-water mixed liquid is introduced into the first chamber, the guide section of the upper partition plate inclines downward from the first chamber toward the second chamber and extends to a position lower than an upper end of the lower partition plate.

3. The oil-water separation device according to claim 1, wherein the upper partition plate includes a partition section disposed between the first discharge port and the second discharge port positioned on left and right sides in an up-down direction, and the inclined guide section continuously formed on a lower side of the partition section.
